(19) United States
(12) Patent Application Publication
(10) Pub. No.: US 2017/0013131 A1
(43) Pub. Date: Jan. 12, 2017

(54) PREDICTIVE AGENT-LEAD MATCHING

(71) Applicant: Data Prophet (Pty) Ltd., Cape Town (ZA)

(72) Inventor: Richard Craib, Cape Town (ZA)

(21) Appl. No.: 14/829,641

(22) Filed: Aug. 19, 2015

Related U.S. Application Data
(60) Provisional application No. 62/189,209, filed on Jul. 7, 2015.

(51) Int. Cl. H04M 3/523; G06Q 10/06; G06Q 30/00; G06N 5/04

(52) U.S. Cl. CPC H04M 3/5233; G06N 5/04; G06Q 10/063112; G06Q 30/016

(57) ABSTRACT

A system for providing predictive agent-lead matching, comprising an agent-lead matching server that receives information from network-connected systems operating within a contact center, analyzes the received information, and identifies data correlations between portions of received information; and a routing server that receives communications from user devices, and directs communications to agent workstations operating within a contact center.

### CROSS-REFERENCE TO RELATED APPLICATIONS

The present application claims the benefit of, and priority to, U.S. provision patent application Ser. No. 62/189,209, titled “PREDICTIVE AGENT-LEAD MATCHING” and filed on Jul. 7, 2015, the entire specification of which is incorporated herein by reference in its entirety.

### BACKGROUND OF THE INVENTION

Field of the Art

The disclosure relates to the field of contact center operations, and more particularly to the field of optimizing agent selection to improve sales.

Discussion of the State of the Art

In the art of contact center operations, new client interactions are often referred to as “leads”, such as prospective customers considering a purchase, for example. A great deal of effort is put into trying to maximize the “yield” of leads, or the number of sales or other desired metrics on a per-lead basis (such as revenue-per-lead, for example). In contact centers, agents are often selected for call routing based on their known skills or training, as well as based on metricized performance results such as customer satisfaction or sales quantity within a given time frame, or other commonly-tracked contact center agent metrics.

These solutions offer an effective, but inefficient solution to driving sales leads, and incorporate only a very shallow form of data-driven optimization using simple metrics-based operation. There is no way to identify deeper trends within a body of agents or a customer base, or to proactively predict how to route a new lead without additional information that is not available in current arrangements.

What is needed, is a means to provide deep-data analysis and form predictions for use in agent-lead matching, to proactively identify agents and optimize matching of leads with agents to improve sales.

### SUMMARY OF THE INVENTION

Accordingly, the inventor has conceived and reduced to practice, in a preferred embodiment of the invention, a system and method for performing predictive agent lead matching within a contact center environment, that utilizes machine learning and algorithmic analysis to identify relationships between agents, lead information, and successful leads.

According to a preferred embodiment of the invention, a system for performing agent-lead matching, comprising an agent-lead matching server comprising at least a plurality of programming instructions stored in a memory operating on a network-connected computing device and configured to receive information from a plurality of network-connected systems operating within a contact center, analyze at least a portion of the received information, and determine a plurality of data correlations between portions of received information based at least in part on the analysis results; and a routing server comprising at least a plurality of programming instructions stored in a memory operating on a network-connected computing device and configured to receive a plurality of communications from at least a plurality of network-connected user devices, and to direct at least a portion of the communications to a plurality of agent workstations operating within a contact center, is disclosed.

According to another preferred embodiment of the invention, a method for providing predictive agent-lead matching, comprising the steps of receiving, at an agent-lead matching server comprising at least a plurality of programming instructions stored in a memory operating on a network-connected computing device and configured to receive information from a plurality of contact center systems via a network, analyze at least a portion of the received information, and determine a plurality of data correlations between portions of received information based at least in part on the analysis results, a plurality of information from at least a plurality of network-connected system operating within a contact center; analyzing at least a portion of the received information; and identifying data correlations between at least a portion of the plurality of received information, the data correlations being based at least in part on at least a portion of the analysis results, is disclosed.

According to another preferred embodiment of the invention, method for adaptive lead prioritization, comprising the steps of analyzing, using an agent-lead matching server comprising at least a plurality of programming instructions stored in a memory operating and operating on a processor of a computing device and configured to receive a plurality of lead-matching information from a plurality of information sources, the plurality of lead-matching information comprising at least a plurality of customer-related information and a plurality of agent-related information, and configured to analyze at least a portion of the plurality of lead-matching information, and configured to determine at least a plurality of data correlations between at least a portion of the customer-related information and at least a portion of the agent-related information, the determination being based at least in part on the analysis results, a plurality of previous leads; producing a plurality of data inferences based at least in part on at least a portion of the previous lead analysis results; analyzing a plurality of new leads; and ranking at least a portion of the plurality of new leads according to their likelihood of success, the ranking based at least in part on at least a portion of the data inferences and at least a portion of the new lead analysis results, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for providing predictive agent lead matching within a contact center environment, according to a preferred embodiment of the invention.

FIG. 6 is a method flow diagram illustrating an exemplary process for performing predictive agent lead matching, according to a preferred embodiment of the invention.

FIG. 7 is a block diagram of an exemplary system architecture for providing predictive agent lead matching, illustrating the use of cloud-based analytics.

FIG. 8 is a block diagram of an exemplary system architecture for providing predictive agent lead matching, illustrating the use of distributed agent workstations.

FIG. 9 is a flow diagram illustrating an exemplary method for agent lead matching.

FIG. 10 is a flow diagram illustrating an exemplary method for priority lead identification.

### DETAILED DESCRIPTION

The inventor has conceived, and reduced to practice, in a preferred embodiment of the invention, a system and method for performing predictive agent lead matching within a contact center environment, that utilizes machine learning and algorithmic analysis to identify relationships between agents, lead information, and successful leads.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

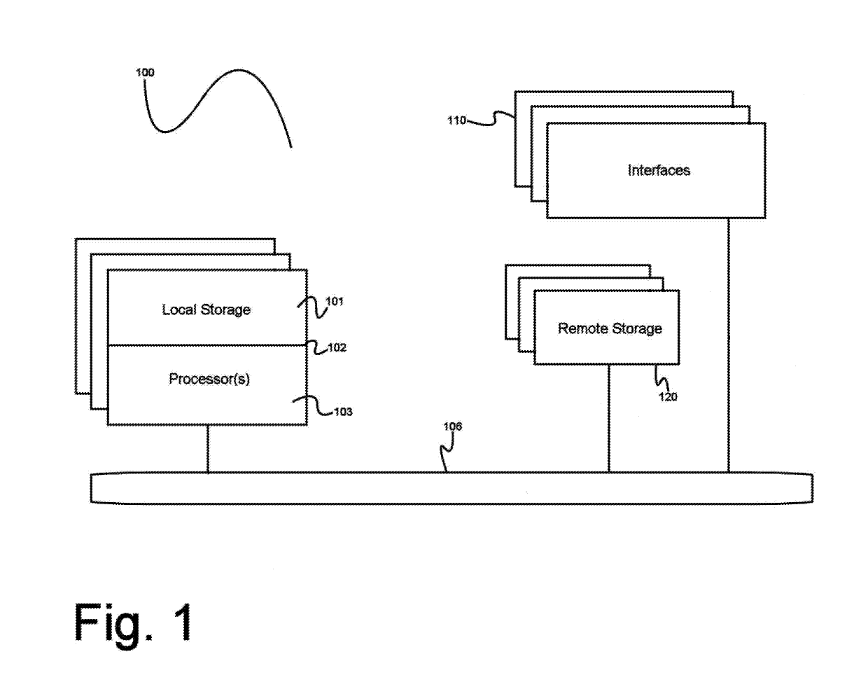

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

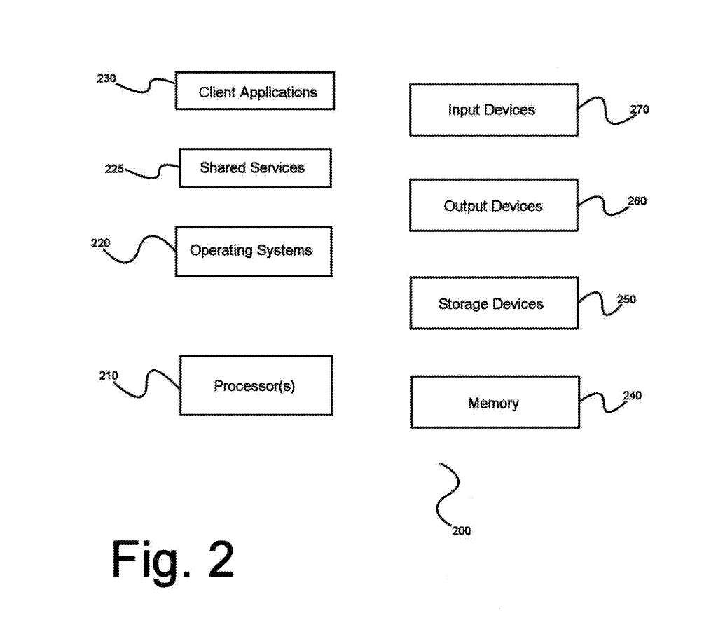

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

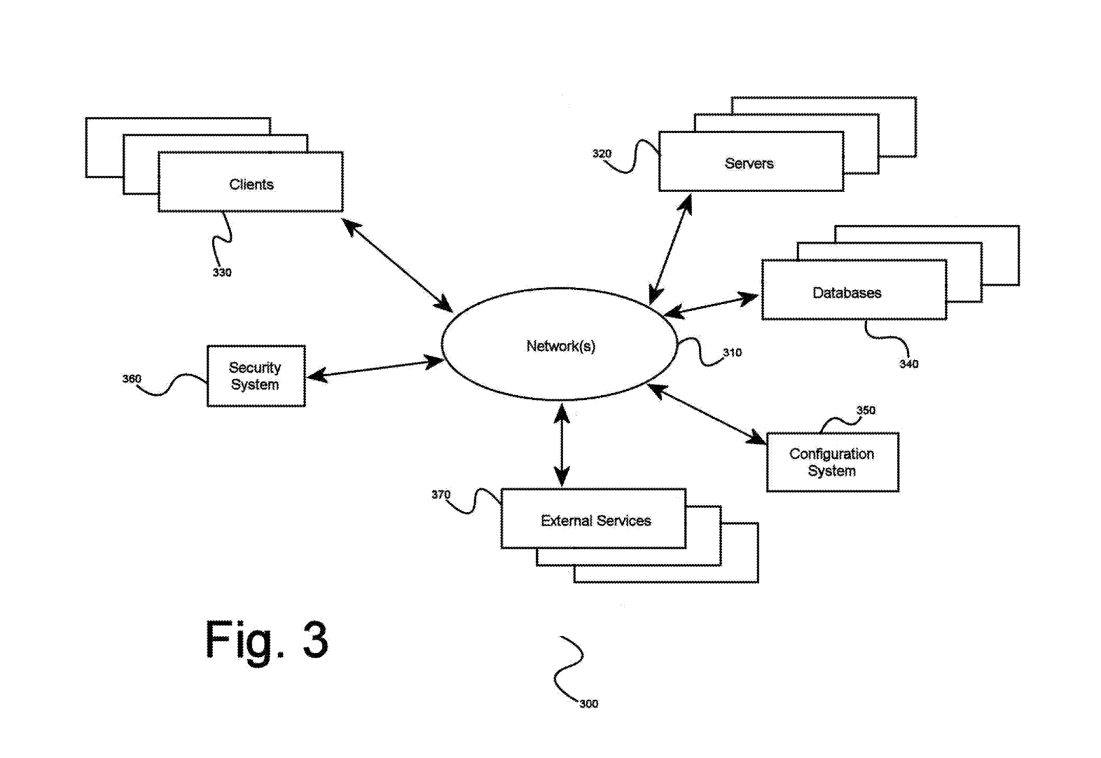

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

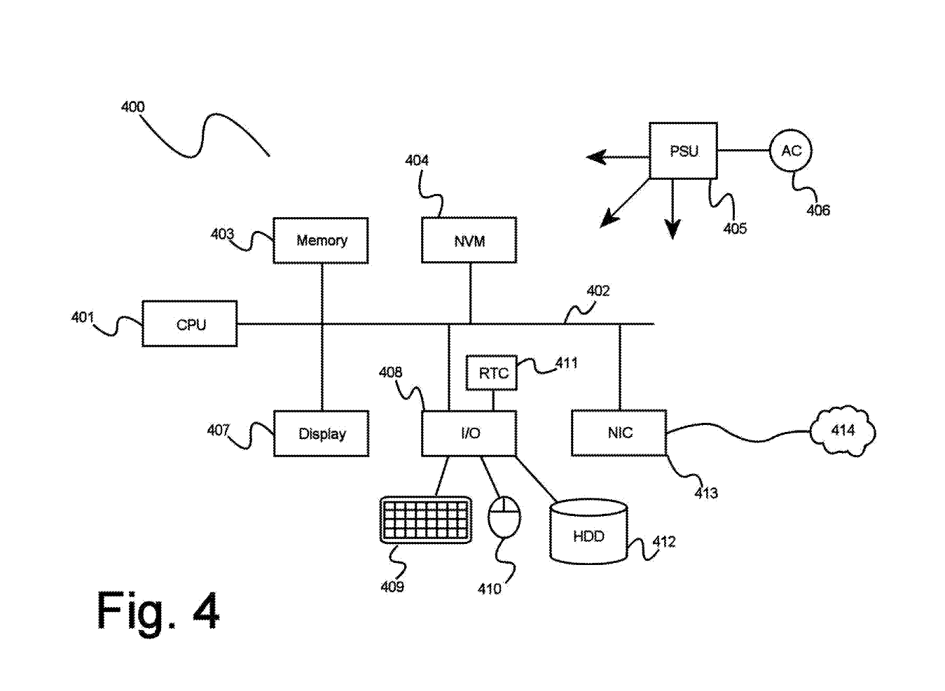

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

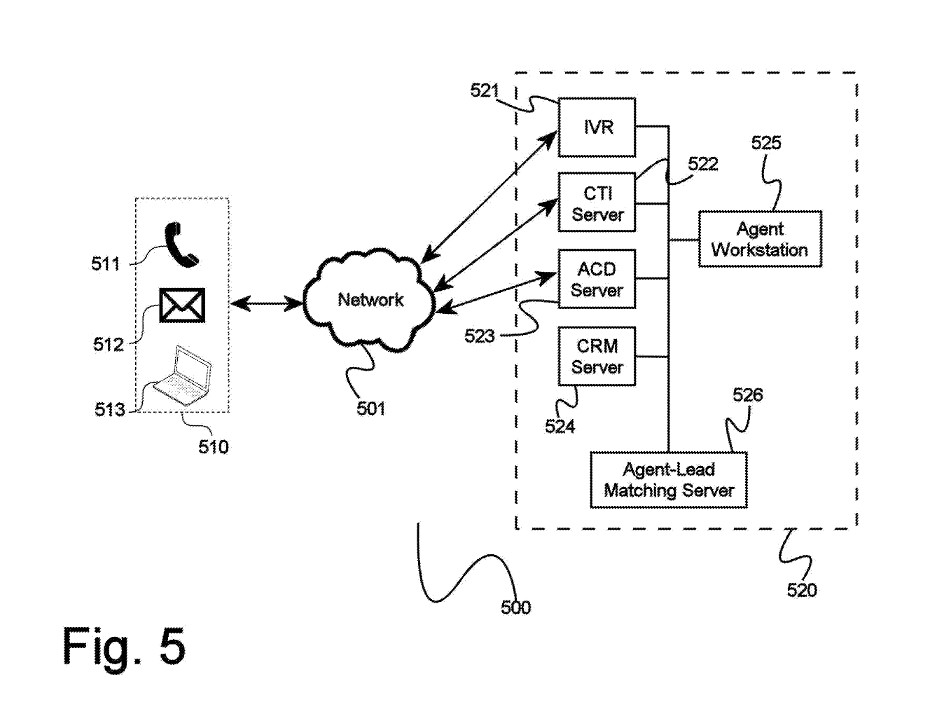

FIG. 5 is a block diagram of an exemplary system architecture 500 for providing predictive agent lead matching within a contact center environment, according to a preferred embodiment of the invention. According to the embodiment, a variety of client devices 510 such as a telephone 511, email 512, or personal computer 513 may communicate with a contact center 520 via a network 501 such as the Internet or other suitable communication network. According to the nature of a particular client device or interaction, various contact center system components may be utilized to handle the interaction, for example a telephone call may be received and processed by a computer telephony integration (CTI) server 522 that may provide the interaction to a contact center agent workstation 525 for handling, or a telephone caller may interact with an interactive voice response (IVR) system 521 and interact with various prompts as is a common practice in the art, and the call interaction may then be processed by an automated call distributor (ACD) 523 and provided to an agent 525 for handling.

According to the embodiment, an agent-lead matching (ALM) server 526 may comprise a plurality of programming instructions stored in a memory operating on a network-connected computing device, and configured to operate in two-way communication with contact center components. ALM server 526 may receive communication from components, for example customer interaction information from an IVR 521, telephony information from a CTI server 522 or ACD server 523, customer account information from a customer relations management (CRM) server 524, or agent or interaction information from an agent workstation 525. Received information may then be analyzed to identify patterns, trends, or correlations between data, for example to identify that a number of interactions pertaining to a particular product have been producing positive results in customer satisfaction (CSAT) surveys, or that a particular agent has an unusually high quantity of successful sales of a particular product or service to customers in a particular region (as may be identified from customer account information). Identified correlations may then be used to generate predictions based on observed data, for example predicting that an agent with high sales success to a particular region may be a better fit for callers matching that region, or that callers from a neighboring region may also be likely to lead to successful sales by that agent. ALM server 526 may then instruct contact center systems to configure their function according to predictions, for example by directing an ACD server 523 to route calls from a particular region to an agent with high sales success with callers in that region, or to direct callers regarding a particular product to a specific agent that has been shown to result in positive CSAT survey feedback regarding that product. In this manner, utilization of ALM server 526 may provide an added two-way data analysis and action functionality to a contact center, enabling adaptive configuration of call routing or other systems to improve operation.

Further according to the embodiment, ALM server 526 may operate selectively on only a portion of data or incoming customer interactions, for example to provide a testing arrangement wherein a portion of customers may be selected to function as a control group, without their data being analyzed or without being routed according to prediction results. For example, during contact center operations a portion of customer interactions may be algorithmically selected to be analyzed and used in generating predictions, while another portion of interactions may be selected to be excluded from analysis and routed according to previous configuration rules. In this manner, ALM server 526 may be used to provide in-place testing of operation, to determine the effects of analysis and prediction according to the embodiment, or may be used to perform a variety of A/B or other testing types to optimize operation.

### DETAILED DESCRIPTION OF EXEMPLARY EMBODIMENTS

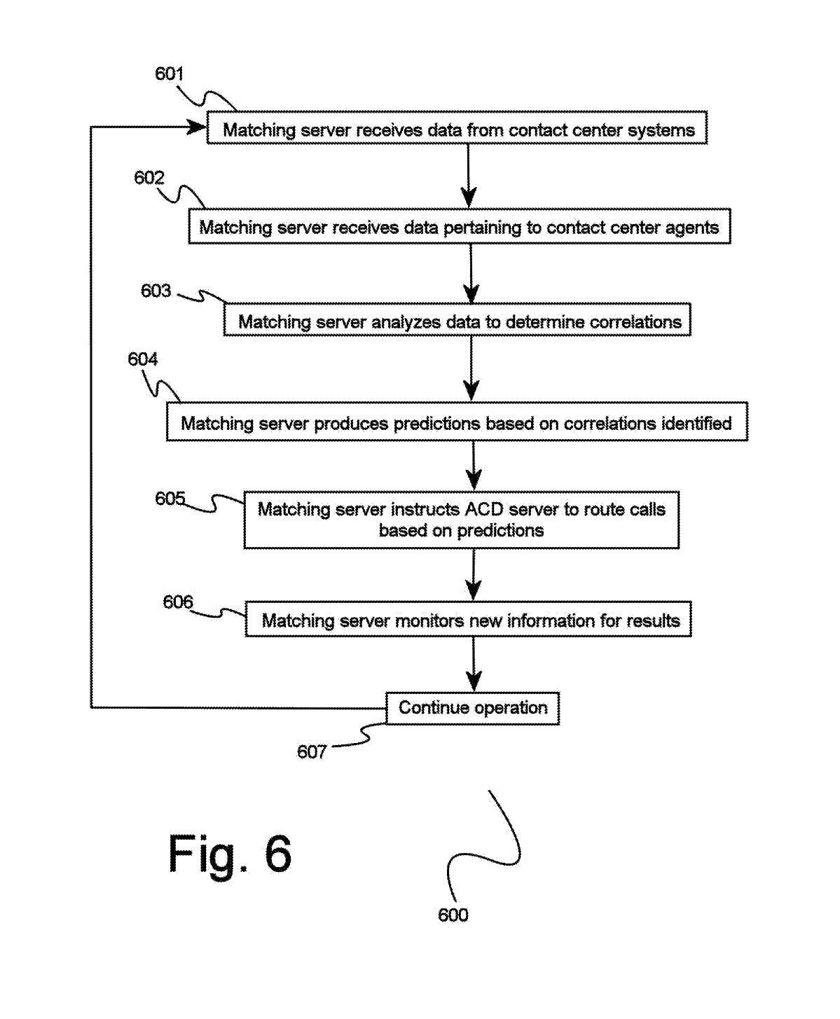

FIG. 6 is a method flow diagram illustrating an exemplary process 600 for performing predictive agent lead matching, according to a preferred embodiment of the invention. In an initial step 601, an agent-lead matching (ALM) server may receive a plurality of data from a plurality of contact center systems, such as including but not limited to an automated call distributor (ACD), computer telephony integration (CTI) server, interactive voice response (IVR) system, or a plurality of agent workstations. In a next step 602, ALM server may receive a plurality of agent-specific data, for example sales or metric scores, as are commonly tracked and stored in contact center operations. In a next step 603, ALM server may analyze received data to identify correlations, patterns, trends, or other relationships between individual data portions. In a next step 604, ALM server may generate a plurality of predictions based at least in part on analysis results, such as (for example) identifying that a particular agent may be well suited for customers matching certain criteria such as demographic or regional information. In a next step 605, ALM server may direct an ACD operated by a contact center to route at least a portion of customer interactions based at least in part on produced predictions, such as (for example) to route new customer interactions matching a demographic profile to a particular agent predicted to be highly-qualified to handle such interactions. In a next step 606, ALM server may continue monitoring contact center operations, receiving new information and performing new analysis, enabling the incorporation of prediction outcomes in analysis operations and facilitating an adaptive and continuous operation. In a final step 607, operation continues in an iterative or looping manner, wherein an ALM server continues to receive and analyze data, form predictions, and direct an ACD to route customer interactions according to predictions.

In this manner, a contact center may improve successful sales through continuous analysis of operations, identifying data relationships that may be used to predict a “most likely path” to achieve a sale on new leads. A variety of data may be used in various combinations, for example customer account information may be used to identify regional or demographic information, revealing data relationships such as “this agent has a high success rate with males customers between the ages of 20-29 in this city”, which may then be used in predictively assigning new leads (that is, routing customer interactions such as calls via an ACD), and monitoring the results.

According to the embodiment, a number of seemingly unrelated metrics or other data may be combined in analysis and predictions, to provide a “deep analysis” through the use of complex data matching and machine learning. Additionally, a portion of customer interactions may be selected for use in “conjectural agent-lead matching” predictions, wherein a prediction may be formed to test a possible correlation or data combination that may not have been explicitly indicated by observed data. For example, if a number of customers from a particular geographic region are interested in product “A”, it may be apparent that sales can be improved by routing them to an agent “A” knowledgeable about product A. However, it may be observed that another agent “B” (who may not be particularly knowledgeable about product A) has a high sales success rate with customers from this region matching a particular demographic profile, “male callers within the ages of 20 and 30”, which may initially seem to be unrelated to the customers calling to inquire about product A. However, conjectural prediction may select a portion of customers calling about product A and route them to agent B, to test if there may be an unobserved factor that is causing agent B's sales success. For example, it may be that customers are calling regarding product A due to a recent endorsement by a sports team in their region, and agent B has a high success rate (unrelated to product A) with customers matching “male, 20-30 years old, within this region”, a demographic group that may be likely to have an interest in sports, due to sharing an interest in the local team (thus making sales based on sentiment, rather than technical product knowledge). Therefore, agent B may be more likely to sell product A despite agent A's advantage in terms of technical knowledge, due to a shared interest with customers regarding their sports team, a data relationship that may not ordinarily be observable (for example, there may be no explicit record of sports affiliations for customers or agents). These connections may not ordinarily be evident, but by incorporating deep analysis and machine learning, as well as optionally using conjectural prediction, operations may be further optimized.

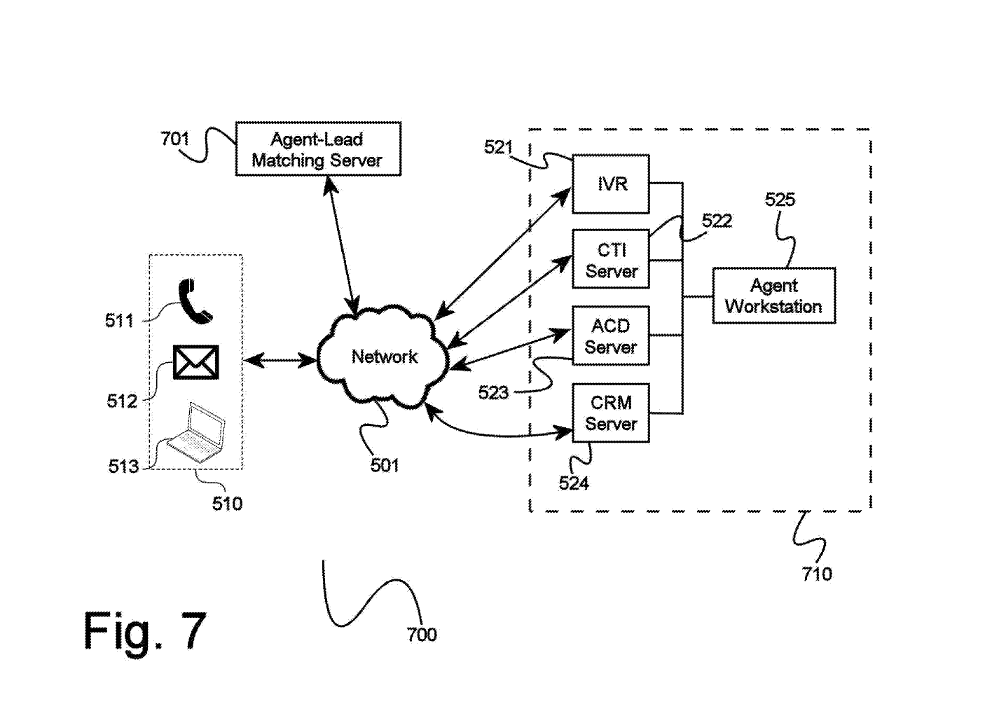

FIG. 7 is a block diagram of an exemplary system architecture 700 for providing predictive agent lead matching, illustrating the use of cloud-based analytics. According to the embodiment, a variety of client devices 510 such as a telephone 511, email 512, or personal computer 513 may communicate with a contact center 710 via a network 501 such as the Internet or other suitable communication network. According to the nature of a particular client device or interaction, various contact center system components may be utilized to handle the interaction, for example a telephone call may be received and processed by a computer telephony integration (CTI) server 522 that may provide the interaction to a contact center agent workstation 525 for handling, or a telephone caller may interact with an interactive voice response (IVR) system 521 and interact with various prompts as is a common practice in the art, and the call interaction may then be processed by an automated call distributor (ACD) 523 and provided to an agent 525 for handling.

According to the embodiment, a cloud-based agent-lead matching (ALM) server 701 may be utilized in addition to or in place of an ALM server operated by a contact center (as described previously, referring to FIG. 5) by communicating with systems operated by a contact center (as described above) via a network. For example, a cloud-based ALM server 701 may be operated by a third-party vendor providing ALM operation via a network in a “software-as-a-service” (SaaS) business model, or may be operated by a business in an offsite location physical separate from a contact center operated by the same business, for example to service multiple contact centers using a single ALM server 701. ALM server 701 may receive communication from components, for example customer interaction information from an IVR 521, telephony information from a CTI server 522 or ACD server 523, customer account information from a customer relations management (CRM) server 524, or agent or interaction information from an agent workstation 525. According to a particular arrangement, a variety of contact center systems (such as, for example, CRM server 524) may communicate via a network 501 using a variety of communication adapters suited to their particular use, such as using a software application programming interface (API) to facilitate communication between CRM server 524 and ALM server 701 via network 501. Received information may then be analyzed to identify patterns, trends, or correlations between data, for example to identify that a number of interactions pertaining to a particular product have been producing positive results in customer satisfaction (CSAT) surveys, or that a particular agent has an unusually high quantity of successful sales of a particular product or service to customers in a particular region (as may be identified from customer account information). Identified correlations may then be used to generate predictions based on observed data, for example predicting that an agent with high sales success to a particular region may be a better fit for callers matching that region, or that callers from a neighboring region may also be likely to lead to successful sales by that agent. ALM server 701 may then instruct contact center systems to configure their function according to predictions, for example by directing an ACD server 523 to route calls from a particular region to an agent with high sales success with callers in that region, or to direct callers regarding a particular product to a specific agent that has been shown to result in positive CSAT survey feedback regarding that product. In this manner, utilization of ALM server 701 may provide an added two-way data analysis and action functionality to a contact center, enabling adaptive configuration of call routing or other systems to improve operation.

An example of particular cloud-based operation according to the embodiment, may be the use of a cloud-based ALM server 701 provided by a vendor to a plurality of contact center clients 710. In such an arrangement, each contact center 710 may provide data to a cloud-based ALM server 701 for use in agent-lead matching, and may choose to provide the particular types or quantities of data desired for their particular use. For example, a contact center 710 may choose not to provide telephone interaction information, for example if they wish to focus on lead matching specifically within a non-telephony context such as for email or other interactions. This selective approach may be used to facilitate a variety of variable or testing modes of operation, for example by utilizing agent-lead matching for specific interaction types and comparing to other interaction types where matching is not being performed, or for performing matching within particular configurable parameters or boundaries, by configuring the data that is provided for use without the need to directly modify the operation of an ALM server 701 (as may be impossible, for example, when ALM server 701 is operated by a third-party).

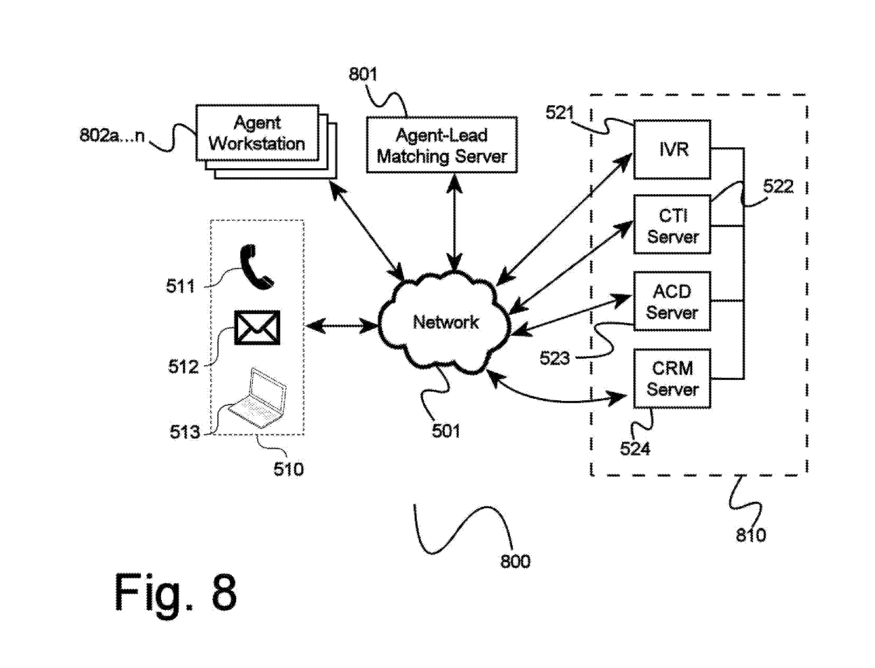

FIG. 8 is a block diagram of an exemplary system architecture 800 for providing predictive agent lead matching, illustrating the use of distributed agent workstations. According to the embodiment, a variety of client devices 510 such as a telephone 511, email 512, or personal computer 513 may communicate with a contact center 810 via a network 501 such as the Internet or other suitable communication network. According to the nature of a particular client device or interaction, various contact center system components may be utilized to handle the interaction, for example a telephone call may be received and processed by a computer telephony integration (CTI) server 522 that may provide the interaction to a plurality of distributed contact center agent workstations 802a-n communicating via a network 501 for handling, or a telephone caller may interact with an interactive voice response (IVR) system 521 and interact with various prompts as is a common practice in the art, and the call interaction may then be processed by an automated call distributor (ACD) 523 and provided to an agent 802a-n for handling. According to the embodiment, a cloud-based agent-lead matching (ALM) server 701 may be utilized in addition to or in place of an ALM server operated by a contact center (as described previously, referring to FIG. 5) by communicating with systems operated by a contact center (as described above) via a network.

According to the embodiment, a plurality of distributed agent workstations 802a-n may communicate via network 501 to interact with systems operated by contact center 810, for example, to receive customer account information from CRM server 524 or to participate in a customer interaction received by contact center 810 such as via an IVR 521. In such an arrangement, agent workstations 802a-n may receive interactions as determined by an ALM server 801, for example when an agent is matched with a potential lead. ALM server 801 may then direct relevant contact center systems such as CRM server 524 to provide appropriate information to a particular agent workstation (for example, if a specific agent is selected for a particular lead, based on the results of agent-lead matching), providing the agent with the relevant information they need to begin or continue an interaction with a customer.

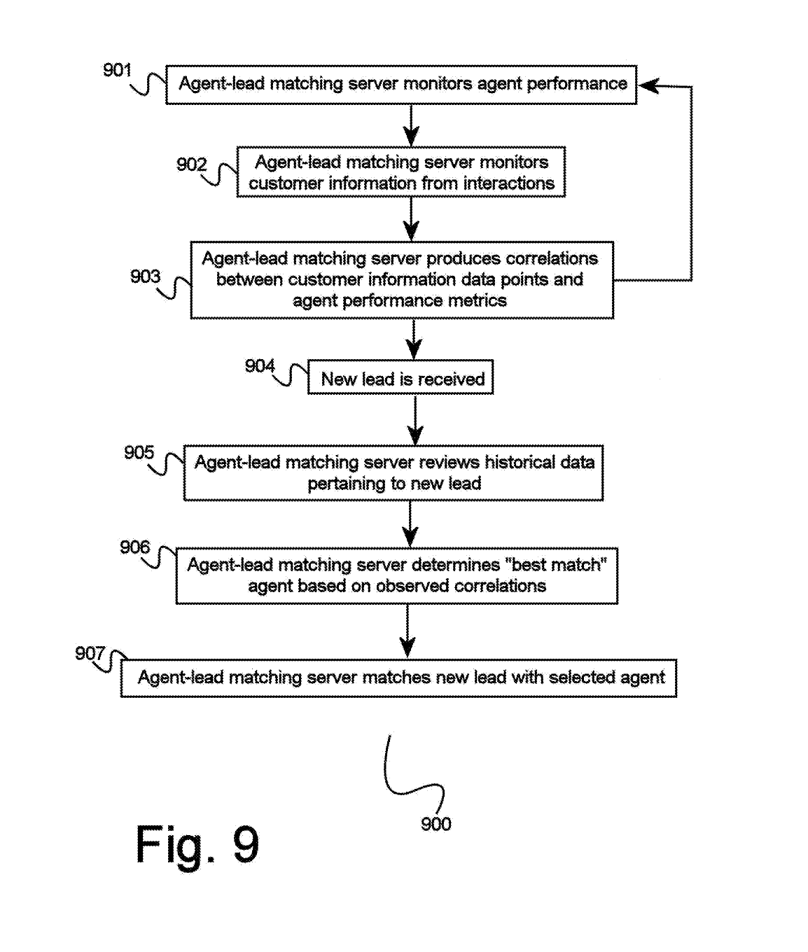

FIG. 9 is a flow diagram illustrating an exemplary method 900 for agent lead matching. In an initial step 901, an agent-lead matching server may monitor performance of a plurality of contact center agents, for example operating within the physical environment of a contact center or geographically distributed and communicating via a network. Various agent metrics may be monitored, such as for example an agent's call handle time, customer survey scores, sales performance (such as “how many sales within this timeframe”, or “percentage of general inquiry calls turned into successful sales”, or any other such sales-related performance criteria), technical statistics such as an agent's usage of a product knowledgebase or demonstrated technical familiarity with products, or any other agent-specific information that may be monitored and qualified or quantified for further use.

In a next step 902, the ALM server may monitor customer interactions for customer-related information, such as (for example) interaction topic, repeat calls (whether a particular customer has had to repeatedly call for assistance with the same issue), account information, or demographic information such as age, gender, or geographic location, or any other such customer-specific information. Additionally, in some arrangements the ALM server may also retrieve customer information from a CRM server operating within a contact center, for example to lookup additional information pertaining to a current interaction, or to look up historical information for additional analysis as described below.

In a next step 903, the ALM server may identify correlations between agent and customer data, identifying trends or patterns that may be used to match leads with agents as described below. For example, it may be recognized that a particular agent has a high sales success rate with male callers, or that they spend an undesirable length of time in an interaction when the caller has a technical issue. Operation may continue iteratively from a previous step 901, with the ALM server continually monitoring agent and customer information to “train” itself using machine learning, incorporating new data and drawing new correlations in a continuous, automated fashion.

In a next step 904, a new lead may be received by a contact center. This may be a prospective new customer, a referral, a current customer interested in new products, or any other opportunity for new sales. In a next step 905, the ALM server may review any known data that may be relevant to the new lead, such as existing customer account information (for a customer interested in making a new purchase) or related accounts (for a customer referral), as well as known agent information and any previously-identified correlations that may incorporate relevant customer information, agent information, or both. This enables each new lead to be analyzed and compared against an existing body of analysis data from steps 901-903.

In a next step 905, the ALM server may determine a “best match” for the new lead based on analysis, for example a specific agent or group of agents such as those possessing particular training, those within a particular geographic location (such as with distributed agents operating via a network), those with similar personal information such as age or gender, or any other arbitrary grouping or ranking of agents. In a final step 907, the ALM server may match the lead with a “best match” agent, either a particular agent or one selected from a group of ideal candidates as described previously. The ALM server may then provide this match data for use by a contact center, so that the lead may be routed to the chosen agent or relevant information may be provided to them for use in acting on the lead.

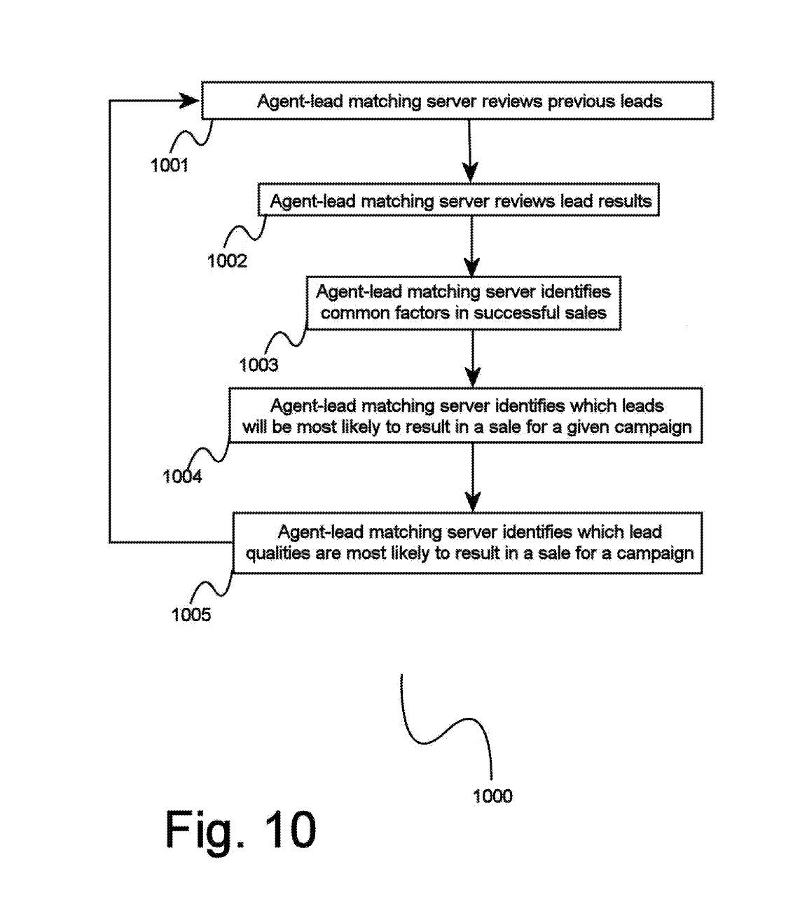

FIG. 10 is a flow diagram illustrating an exemplary method 1000 for priority lead identification. In an initial step 1001, an agent-lead matching server may review a plurality of previous leads, optionally including leads that were matched by an ALM server or leads that were not matched and were handled traditionally, or both. In a next step 1002, the ALM server may review the results of previous leads, for example whether or not a lead resulted in a sale, or optionally more detailed information such as “how many units were purchased” or alternate or non-sales information such as (for example) new leads resulting from one original lead (as may occur, for example, when one party inquires about a product or service and does not purchase, but recommends it to others).

In a next step 1003, the ALM server may identify common factors in successful sales (or other “successful” lead types, such as referrals or other non-sales leads according to a particular arrangement or use case). Such factors may include a wide variety of information associated with a lead, customer, agent, or interaction, such as including (but not limited to) customer demographic information (age, race, gender, location, or other customer-specific information), agent-specific information such as agent demographics, training or skills, or language-based information (for example, agents who are fluent in a particular language, or who are from a certain region and may be familiar with localized linguistic details such as slang or accent), or interaction-specific details such as at what time an interaction took place, how long an interaction lasted, what communication means were utilized, or any other such information that may be associated with a specific customer, agent, interaction, or lead. It should be appreciated that a “lead” and a “customer” may or may not be synonymous according to the nature of a particular lead, for example an individual calling about a potential sale may be both the “customer” and the “lead”, whereas a designated representative for a corporation may call on behalf of their organization and be considered the “lead”, while the corporate entity is the “customer” (for example, a company's geographic location may not be the same as that of their purchasing agent).

In a next step 1004, these common factors may be used by the ALM server to identify which leads from a plurality of new or prospective leads (such as pending interactions waiting to be matched or outbound interactions to be placed) will most likely result in a “success” for a given campaign. For example, it may be determined that leads within a particular geographic region are more likely to purchase a specific product being promoted currently, or that a specific lead is a good match for a specific product and may be given a high priority next time that product is prioritized for sales. In a next step 1005, the ALM server may identify which lead qualities or characteristics may be likely to result in a “success” for a given campaign, enabling enhanced analysis of future leads by identifying desirable traits that may be used as indicators of lead success. In this manner, leads may be prioritized based on their predicted likelihood of success, and new leads may be prioritized based on shared traits with previously-successful leads. Operation may then continue with an initial step 1001, facilitating a continuous and adaptive operation cycle to incorporate and analyze new leads and automatically incorporate new data into analysis and prioritization. Prioritized leads may then be utilized by a contact center for manual operation such as to produce lists of outbound interactions for agent follow-up, or they may be automatically matched with agents based on their priority or based on agent-lead matching analysis as described above in FIG. 9, or both. For example, once leads have been prioritized a subset of only “highest priority leads” may be used for agent-lead matching, so that only the leads that are most likely to succeed are pursued, and they are then matched with ideal agents to further increase likelihood of success.

In another embodiment, leads may be matched using “time-allocation matching”. The general approach may be similar to priority lead matching as described above (referring to FIG. 10), but a focus is placed on time-based data and rather than matching leads with specific agents, leads may be matched based on specific timeframes, such as “this lead is most likely to result in a success if we call them between the hours of 10:00 and 12:00 in their local time”. In a time-allocation matching arrangement, an ALM server may particularly analyze time-based information associated with leads, customers, agents, or interactions. This time-based data may then be compared against lead successes to identify correlations in a manner similar to identifying correlations with other data characteristics as described above (referring to FIGS. 9-10), for example identifying that “leads within this geographic region are more likely to result in a success if interaction occurs in the early morning”, or other such correlations. Based on this information, leads may be prioritized based on their time-allocation needs, such that at any given point during the day a subset of leads is given a high priority (those that are more likely to result in a success at that time), and throughout the day that subset is continually modified to contain only those leads that are most likely to be successful. Alternately, leads may be scheduled based on their time-allocation prioritization, where leads may be distributed to agents and scheduled for interaction within their particular time-allocation window. Agents may optionally be selected based on their own time-allocation information (such as agents that are known to be scheduled for availability within a certain timeframe, or agents that are known to be more positive or productive during certain times, or other such time-based information and correlations), or they may be selected arbitrarily or according to other agent-lead matching methods as described previously (referring to FIG. 9).

Further according to the embodiments described herein, a portion of customer interactions may be selected to serve as a control group during predictive agent-lead matching according to any of the methods described previously (or any additional or alternate methods that may be utilized in agent-lead matching), for example by being excluded from analysis and being routed according to previously-established rules (that is, without incorporating any new routing rules based on prior analysis or prediction results). Using a control group may be valuable to determine the impact agent-lead matching is having on operations, for example to compare rate of sales leads without predictive optimization to rate with predictive optimization, or to compare between two sets of predictive matching, such as one utilizing conjectural matching for a portion of interactions, and one that uses no conjectural matching. In this manner contact center operation may be further optimized through the use of testing, to identify what configurations or modes of operation are more successful and incorporate them for greater efficacy.

The skilled person will be aware of a range of possible modifications of the various embodiments described above. Accordingly, the present invention is defined by the claims and their equivalents.

What is claimed is:

1. A system for performing predictive agent-lead matching, comprising:
an agent-lead matching server comprising at least a plurality of programming instructions stored in a memory operating and operating on a processor of a computing device and configured to receive a plurality of lead-matching information from a plurality of information sources, the plurality of lead-matching information comprising at least a plurality of customer-related information and a plurality of agent-related information, and configured to analyze at least a portion of the plurality of lead-matching information, and configured to determine at least a plurality of data correlations between at least a portion of the customer-related information and at least a portion of the agent-related information, the determination being based at least in part on the analysis results; and
a routing server comprising at least a plurality of programming instructions stored in a memory and operating on a processor of a network-connected computing device and configured to receive a plurality of customer interactions from a plurality of customer interaction systems operating within a contact center, and configured to receive a plurality of data correlations from an agent-lead matching server, and to direct at least a portion of the customer interaction to a plurality of agent workstations operating within a contact center, the direction being based at least in part on at least a portion of the plurality of data correlations.

2. The system of claim 1, wherein the plurality of information sources comprises at least a CRM server comprising at least a plurality of programming instructions stored in a memory and operating on a processor of a computing device and configured to store and provide at least a plurality of customer-related information.

3. The system of claim 1, wherein the plurality of data correlations comprises at least a plurality of predictive correlations based at least in part on at least a portion of the customer-related information.

4. The system of claim 3, wherein the plurality of predictive correlations are based at least in part on previously-received customer-related information.

5. The system of claim 1, wherein the routing server is an automated call distributor and is configured to route a plurality of telephone calls to at least a portion of a plurality of agent workstations operating within a contact center.

6. The system of claim 1, wherein the routing server is an email server comprising at least a plurality of programming instructions stored in a memory and operating on a processor of a network-connected computing device and configured to receive and provide email information.

7. A method for providing predictive agent-lead matching, comprising the steps of:
receiving, at agent-lead matching server comprising at least a plurality of programming instructions stored in a memory operating and operating on a processor of a computing device and configured to receive a plurality of lead-matching information from a plurality of information sources, the information comprising at least a plurality of customer-related information and a plurality of agent-related information, and configured to analyze at least a portion of the customer-related information, and configured to determine at least a plurality of data correlations between at least a portion of the customer-related information and at least a portion of the agent-related information, the determination being based at least in part on the analysis results, a plurality of lead-matching information comprising at least a plurality of customer-related information and a plurality of agent-related information from a plurality of customer interaction systems operating within a contact center;
analyzing at least a portion of the plurality of lead-matching information; and
identifying data correlations between at least a portion of the plurality of customer-related information and at least a portion of the agent-related information, the data correlations being based at least in part on at least a portion of the analysis results.

8. The method of claim 7, further comprising the steps of:
producing a plurality of predictions based at least in part on at least a portion of the identified data correlations; and
providing at least a portion of the plurality of predictions to a routing server comprising at least a plurality of programming instructions stored in a memory operating on a network-connected computing device and configured to receive a plurality of communications from at least a plurality of network-connected user devices, and to direct at least a portion of the communications to a plurality of agent workstations operating within a contact center.

9. A method for adaptive lead prioritization, comprising the steps of:
analyzing, using an agent-lead matching server comprising at least a plurality of programming instructions stored in a memory operating and operating on a processor of a computing device and configured to receive a plurality of lead-matching information from a plurality of information sources, the plurality of lead-matching information comprising at least a plurality of customer-related information and a plurality of agent-related information, and configured to analyze at least a portion of the plurality of lead-matching information, and configured to determine at least a plurality of data correlations between at least a portion of the customer-related information and at least a portion of the agent-related information, the determination being based at least in part on the analysis results, a plurality of previous leads;
producing a plurality of data inferences based at least in part on at least a portion of the previous lead analysis results;
analyzing a plurality of new leads; and
ranking at least a portion of the plurality of new leads according to their likelihood of success, the ranking based at least in part on at least a portion of the data inferences and at least a portion of the new lead analysis results.
